(19) United States
(12) Patent Application Publication
(10) Pub. No.: US 2010/0223956 A1
(43) Pub. Date: Sep. 9, 2010

(54) FLOAT BATH SYSTEM FOR MANUFACTURING FLOAT GLASS

(76) Inventors: Won-Jae Moon, Seoul (KR); Sang-Oeb Na, Seoul (KR); Yang-Han Kim, Goyang-si (KR); Hyung-Young Oh, Goyang-si (KR); Young-Sik Kim, Seoul (KR); Kil-Ho Kim, Suwon-si (KR); Heui-Joon Park, Bupyeong-gu (KR); Chang-Hee Lee, Osan-si (KR)

Correspondence Address: MCKENNA LONG & ALDRIDGE LLP, 1900 K STREET, NW, WASHINGTON, DC, 20006, US

(21) Appl. No.: 12/715,127

(22) Filed: Mar. 1, 2010

(30) Foreign Application Priority Data
Mar. 3, 2009 (KR) 10-2009-0018064

(51) Int. Cl. C03B 40/00

(52) U.S. Cl. 65/169

(57) ABSTRACT

Disclosed is a float bath system for manufacturing a float glass, comprising a block assembly having a plurality of blocks connected to each other and configured to store a molten metal therein; a steel casing surrounding the block assembly; an air blower capable of supplying air to the steel casing; and a coating layer formed on a contact surface of the steel casing with the block assembly to prevent the molten metal from reacting with the steel casing when the molten metal flows in a gap between the blocks of the block assembly.

### CROSS-REFERENCE TO RELATED APPLICATION

This application claims priority to Korean Patent Application No. 10-2009-0018064 filed in Republic of Korea on Mar. 3, 2009, the entire contents of which are incorporated herein by reference.

### BACKGROUND OF THE INVENTION

1. Field of the Invention

The present invention relates to a float bath system for manufacturing a float glass, and more particularly, to a float bath system for manufacturing a float glass which has an improved structure of a steel casing surrounding blocks for molten metal storage.

2. Description of the Related Art

Generally, an apparatus for manufacturing a float glass (also known as a sheet glass, a flat glass or a plate glass) using a float glass process is used to manufacture a continuous sheet of glass having a ribbon shape of a predetermined width by continuously supplying a molten glass onto a flowing molten metal (a molten tin and so on) stored in a float bath while floating the molten glass on the molten metal to form a molten glass ribbon reaching around an equilibrium thickness due to the surface tension and gravity, and pulling up the molten glass ribbon toward an annealing lehr near an exit of the float bath.

Here, the molten metal includes, for example, a molten tin or a molten tin alloy, and has a greater specific gravity than the molten glass. The molten metal is received in a float chamber where a reducing atmosphere of hydrogen (H₂) and/or nitrogen (N₂) gas is introduced. The float bath in the float chamber is configured to contain the molten metal therein. The float bath has a horizontally extending structure, and includes a high heat resistant material (for example, bottom blocks) therein. The molten glass forms a molten glass ribbon on the surface of the molten metal while moving from an upstream end of the float bath to a downstream end. The molten glass ribbon is lifted up at a location set on the downstream end of the float bath, so called a take-off point, to be removed from the molten metal, and delivered to an annealing lehr of a next process.

Meanwhile, the molten metal in the float chamber is maintained in a high-temperature state (for example, about 600 to 1100° C.), and a melting temperature of the molten metal (molten tin) is 232° C. Thus, it needs to cool down the bottom of the float bath to about 120 to 130° C. For this purpose, a conventional float bath system has an air blower for cooling a steel casing of the float bath by blowing an air to the lower surface of the steel casing.

However, if the operation of a driving source, by which the air blower is driven, is suddenly stopped, it takes a considerable time to normalize the operation of the air blower. During the time the air blower is stopped, temperature of the bottom of the float bath increases, and consequently, tin existing around the bottom of the float bath returns into a liquid state and reacts with the steel casing, so that unnecessary alloys are formed and bubbles (O₂) are created. In a severe instance, a hole may be generated in the steel casing, which should be replaced by a new steel casing.

Though a severe instance does not occur, contamination taking place during an abnormal operation as stated above changes the internal temperature of the float bath in the range of, for example −5° C. to +5° C. Such change in temperature changes the flow of molten metal, so that bubbles are created. This phenomenon causes surface defects (OBB (Open Bottom Bubble) or BOS (Bottom Open Seed)) of float glass products.

### SUMMARY OF THE INVENTION

The present invention is designed to solve the above-mentioned problems, and therefore it is an object of the present invention to provide a float bath system for manufacturing a float glass, which has a coating layer of ceramic powder in a steel casing, thereby reducing or preventing the likelihood that the hardened tin near the steel casing melts and reacts with a metal component of the steel casing to generate defects.

To achieve the object, a float bath system for manufacturing a float glass according to the present invention comprises a block assembly having a plurality of blocks connected to each other and configured to store a molten metal therein; a steel casing surrounding the block assembly; an air blower capable of supplying air to the steel casing; and a coating layer formed on a contact surface of the steel casing with the block assembly to prevent the molten metal from reacting with the steel casing when the molten metal flows in a gap between the blocks of the block assembly.

Preferably, the coating layer contains ceramic powder spray-coated on the surface of the steel casing.

Preferably, the ceramic powder includes any one selected from the group consisting of ZrO₂, SiO₂, Al₂O₃, Y₂O₃, Fe₂O₃, HfO₂ and Na₂O.

Preferably, the coating layer has a thickness of about 1 μm.

### EFFECTS OF THE PRESENT INVENTION

The float bath system for manufacturing a float glass according to the present invention has a coating of ceramic powder on the surface of a steel casing, configured to impede a reaction of a leak of molten metal (tin) with the steel casing even in the case of a sudden breakdown of an air blower, so as to prevent very severe defects that may be generated due to a combination of a fine steel component of the steel casing with an oxygen component of the molten tin or to reduce the likelihood that the hardened tin near the steel casing melts and reacts with a metal component of the steel casing to generate defects, thereby improving the quality of float glass products and ensuring the procedural stability.

### BRIEF DESCRIPTION OF THE DRAWINGS

The accompanying drawings illustrate the preferred embodiments of the present invention and are included to provide a further understanding of the spirit of the present invention together with the detailed description of the invention, and accordingly, the present invention should not be limitedly interpreted to the matters shown in the drawings.

FIG. 1 is a schematic front elevation view of a float bath system for manufacturing a float glass according to a preferred embodiment of the present invention.

FIG. 2 is a side view of FIG. 1.

FIG. 3 is an exploded cross-sectional view of section A in FIG. 2.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

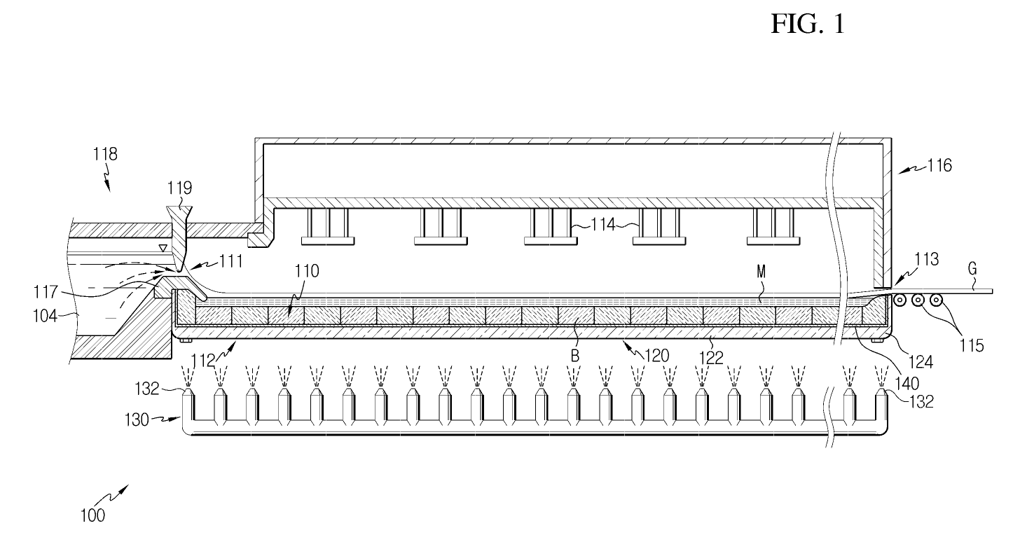

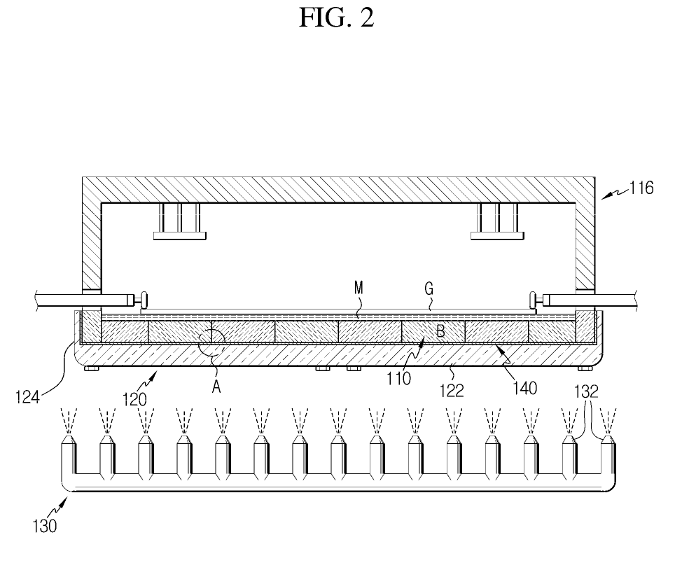

FIG. 1 is a schematic front elevation view of a float bath system for manufacturing a float glass according to a preferred embodiment of the present invention. FIG. 2 is a side view of FIG. 1.

Referring to FIGS. 1 and 2, the float bath system 100 for manufacturing a float glass according to an embodiment of the present invention comprises a block assembly 110, a steel casing 120, an air blower 130 and a coating layer 140. The block assembly 110 includes a plurality of blocks (B) and stores a molten metal (M) therein. The steel casing 120 is installed to surround the block assembly 110. The air blower 130 has an air supply pipe through which air is supplied to the steel casing 120 to cool the steel casing 120. The coating layer 140 is formed on a contact surface of the steel casing 120 with the block assembly 110 to prevent a reaction of the steel casing 120 with the molten metal (M) flowing in gaps between the blocks (B) of the block assembly 110.

The float bath system 100 for manufacturing a float glass according to an embodiment of the present invention is configured to manufacture a float glass using a so called float glass process. The float bath system 100 includes a float chamber 118, and the float chamber 118 has a float bath 112 located at a lower portion thereof and a roof 116 covering the top of the float bath 112 and having electric resistance heating elements 114. The float chamber 118 is an airtight type that has an input port 111 and an output port 113.

The float bath 112 stores a molten metal (M) therein, such as a molten tin, a molten tin alloy and so on. A molten glass (G) is stored in a melting furnace 104, metered through a threshold 117 and a level control tweel 119, and flown into the float bath 112. While the molten glass (G) is supplied from an upstream end of the float bath 112 (shown at the left side of the drawing) and flows to a downstream end (shown at the right side of the drawing), the molten metal (M) runs by the flow of molten glass (G). The molten metal (M) flows from the upstream end of the float bath 112 to the downstream end due to a temperature gradient in the float bath 102, and at the same time, flows from the center of the float bath 112 to both sides of the float bath 112. The temperature gradient is a difference in temperature between the downstream end (Cold End) and the upstream end (Hot End) which is maintained at a relatively higher temperature. The molten glass (G) forms a molten glass ribbon having preferred thickness and width while flowing from the upstream end of the float bath 112 to the downstream end, and the molten glass ribbon is lifted up at a take-off point by lift-out rollers 115 installed at the output port 113 of the float chamber 118, to be removed from the surface of the molten metal (M), and drawn out toward an annealing lehr (not shown) of a next process.

The atmosphere in the float chamber 118 is formed by a mixed gas of nitrogen and hydrogen. The mixed gas is maintained at pressure slightly higher than the external atmosphere, and the molten metal (M) and the molten glass ribbon is maintained at about 800 to 1300° C. by the electric resistance heating elements 114. The molten glass (G) is a nonalkaline glass, a soda-lime glass, and so on. The principle and structure for flow generation of the molten metal (M) in the float bath 112, and input, ribbonization, movement and discharge of the molten glass (G) are well known in a typical float glass process, and the detailed description is omitted herein.

The block assembly 110 is formed by lining connection of a plurality of blocks (B) such as refractory blocks. The block assembly 110 may include bottom lining blocks for directly storing the molten metal (M), and bottom refractory blocks arranged in contact with the inner surface of the steel casing 120 and surrounding the bottom lining blocks. In this case, an inorganic adhesive is preferably filled between the blocks (B) including the bottom lining blocks and the bottom refractory blocks. The interval between the blocks (B) of the block assembly 110 is preferably determined in consideration of length of the blocks (B) that may increase during heating, and so on. The blocks (B) need wear resistance against the molten metal (M), resistance against alkali such as K₂O or Na₂O contained in the molten glass (G), spalling resistance enabling adaptation of float glass products to changes in temperature, and so on. The block assembly 110 may include bottom blocks defining the bottom of the float bath 112 and side blocks defining the side of the float bath 112.

The steel casing 120 includes a bottom casing 122 and a side casing 124. The bottom casing 122 surrounds the bottom blocks, and the side casing 124 is connected with the bottom casing 122 and surrounds the side blocks. Preferably, the steel casing 120 is made of a typical metal having sufficient rigidity and thickness to support the block assembly 110.

The air blower 130 is arranged in a predetermined pattern in a space between a support frame (not shown) and the bottom of the float bath 112, i.e., the lower surface of the steel casing 120. The air blower 130 cools the steel casing 120 down to a predetermined temperature by air going out through air discharge openings 132. Typically, the air blower 130 is driven by a driving source, for example a fan. That is, the blocks assembly 110 and the steel casing 120 that is heated by a high temperature atmosphere in the float bath 112 is cooled by the air blower 130.

The coating layer 140 contains ceramic powder spray-coated on the surface of the steel casing 120. The ceramic powder is not deformed at temperature of about 600° C. The ceramic powder radiates far infrared rays, and has an antibiotic function. The ceramic powder has high adhesive property and high impact resistance and a hardness of 8H or more, and exhibits acid and alkaline resistance. The ceramic powder is excellent in corrosion resistance and weather resistance. The ceramic powder enables formation of a precision film coating layer. Preferably, the ceramic powder includes any one selected from the group consisting of ZrO₂, SiO₂, Al₂O₃, Y₂O₃, Fe₂O₃, HfO₂ and Na₂O. The coating layer 140 has a thickness of about 1 μm.

Described is the operation of a float bath system for manufacturing a gloat glass having the above-mentioned structure according to a preferred embodiment of the present invention.

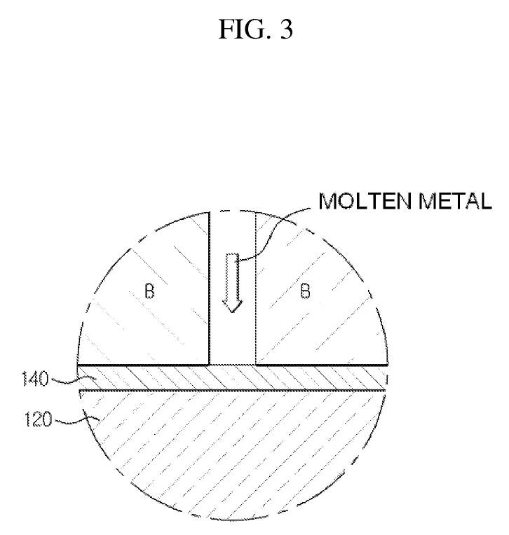

In the float bath system 100 according to an embodiment of the present invention, the steel casing 120 is cooled down to a predetermined temperature by the air blower 130 operated by a fan. If the operation of the fan on the air blower 130 is stopped, a liquid component of the molten metal (M) stored in the float bath 112 may flow in gaps between the blocks (B) and react with the steel casing 120 as shown in FIG. 3. At this time, the surface of the steel casing 120 is protected from the flow of the molten metal (M) by the coating layer 140 made of ceramic powder.

Hereinabove, the present invention is described with reference to the limited embodiments and drawings. However, the description proposed herein is just a preferable example for the purpose of illustrations only, not intended to limit the scope of the invention, so it should be understood that other equivalents and modifications could be made thereto without departing from the spirit and scope of the invention.

What is claimed is:

1. A float bath system for manufacturing a float glass, comprising:
a block assembly having a plurality of blocks connected to each other and configured to store a molten metal therein;
a steel casing surrounding the block assembly;
an air blower capable of supplying air to the steel casing; and
a coating layer formed on a contact surface of the steel casing with the block assembly to prevent the molten metal from reacting with the steel casing when the molten metal flows in a gap between the blocks of the block assembly.

2. The float bath system for manufacturing a float glass according to claim 1,
wherein the coating layer contains ceramic powder spray-coated on the surface of the steel casing.

3. The float bath system for manufacturing a float glass according to claim 2,
wherein the ceramic powder includes any one selected from the group consisting of ZrO₂, SiO₂, Al₂O₃, Y₂O₃, Fe₂O₃, HfO₂ and Na₂O.

4. The float bath system for manufacturing a float glass according to claim 1,
wherein the coating layer has a thickness of about 1 μm.
